(19) United States
(12) Patent Application Publication
(10) Pub. No.: US 2015/0095092 A1
(43) Pub. Date: Apr. 2, 2015

(54) Legal workflow management system

(71) Applicants: Praveen Medikundam, Schaumburg, IL (US); Samuel Alemu, Schaumburg, IL (US)

(72) Inventors: Praveen C. Medikundam, Elgin, IL (US); Samuel Alemu, Elgin, IL (US)

(21) Appl. No.: 14/040,644

(22) Filed: Sep. 28, 2013

(51) Int. Cl. G06Q 10/06

(52) U.S. Cl. CPC G06Q 10/06316
USPC 705/7.26

(57) ABSTRACT

A computerized workflow automation method is provided for defining a business process by a user, implemented by executing instructions stored in memory using a processor coupled to the memory. The method includes: defining the business process and a plurality of tasks associated with the business process, the tasks including a first task and a second task; defining a process level service level agreement (PLSLA) for the process; defining task level service level agreements including at least a first task level service level agreement (TLSLA) for the first task and a second TLSLA for the second task; assigning the first task to a first user group and assigning the second task to a second user group; and storing data representative of the process, each of the tasks, the first TLSLA, the second TLSLA, the PLSLA, and each of the user groups, in the memory.

### FIELD OF THE INVENTION

The present invention relates generally to computerized workflow automation systems and in particular to rule-based, dynamic workflow automation systems for use in professional service firms such as law firms to facilitate timely and transparent service delivery.

### BACKGROUND OF THE INVENTION

The use of workflow automation systems in many professional service firms such as law firms and consulting groups is very helpful and often helps increase the efficiency of the organization. Typical workflow management systems are often complex and require highly specialized teams to install, maintain and run properly. Not surprisingly deployment of workflow automation systems is often very expensive.

Many workflow management systems utilize standardized business process models and definition languages such as the Business Process Modeling Notation (BPMN), and XML Process Definition Language (XPDL). The necessary level of familiarity with these standards that is needed in order to properly define and implement workflows automation systems for complex proprietary workflows requires specialized expertise. Such expertise is often available only to a select, well-trained, workflow programming professionals.

Moreover, even after a workflow system is implemented, firms and organizations may come to depend on professional consultants to make even small modifications to their existing workflow automation.

Many workflow management system vendors often claim to have flexible and adaptable systems that permit drag-and-drop capabilities to make alterations to the workflow. However, very often, many unforeseen background process changes result in the course of utilizing drag-and-drop enabled modifications. Such changes to background processes can be difficult to detect, with potentially adverse effects that may be challenging to correctly trace and rectify.

Another disadvantage of existing conventional workflow automation systems is the lack of simple tools that allow modifications of the workflow process. For organizations that do not have a mature and stable workflow, this can be especially undesirable. Firms with evolving and dynamic workflow processes require flexibility in adjusting their workflow automation systems to match their current practices which may change frequently. The lack of flexibility in adjusting the systems to ever changing processes has been one of the main reasons preventing a more widespread adoption of workflow automation systems.

Accordingly, many improvements are desired in existing workflow automation systems. It is thus an object of the present invention to provide a novel workflow automation system that helps mitigate at least some of the disadvantages associated with current conventional workflow automation systems.

### SUMMARY OF THE INVENTION

In accordance with one aspect of the present invention, there is provided a computerized method of workflow automation for use in a law firm, implemented by executing processor executable instructions stored in memory on a processor coupled to the memory. The method includes: defining a process and a plurality of tasks associated with the process in response to user input, the tasks including a first task and a second task; defining a process level service level agreement (PLSLA) for the process; defining task level service level agreements including at least a first task level service level agreement (TLSLA) for the first task and a second TLSLA for the second task, the first TLSLA and the second TLSLA including a first deadline and a second deadline respectively, assigning the first task to a first user belonging to a first group of legal professionals that are geographically located in a first location; assigning the second task to a second user in a second group of legal professionals that are geographically located in a second location different from the first location; storing data representative of the process, each of the tasks, the first TLSLA, the second TLSLA, the PLSLA, and assignments, in the memory; upon the current time being within a first threshold duration relative to the first deadline; sending a first notification message; determining a first fraction of the legal professionals other than the first user within the first group that are available to be assigned to the first task; and automatically assigning the first task to another group having no common members with the first group, upon the first faction being less than a first predetermined value.

In accordance with another aspect of the present invention, there is provided a system for workflow automation in a law firm including: a processor; and memory coupled to the processor. The memory stores processor executable instructions including: instructions for defining a legal service process, and a plurality of tasks associated with the process in response to user input, the tasks including a first task and a second task; instructions for defining a process level service level agreement (PLSLA) for the process; instructions for defining task level service level agreements including at least a first task level service level agreement (TLSLA) for the first task and a second TLSLA for the second task, the first TLSLA and the second TLSLA including a first deadline and a second deadline respectively; instructions for assigning the first task to a first user belonging to a first group including legal professionals that are geographically located in a first location; instructions for assigning the second task to a second user in a second group including legal professionals that are geographically located in a second location different from the first location; instructions for storing data representative of the process, each of the tasks, the first TLSLA, the second TLSLA, the PLSLA, each user, each group and assignments, in the memory; instructions for, upon the current time being within a first threshold duration relative to the first deadline; sending a first notification message; determining a first fraction of the legal professionals other than the first user within the first group that are available to be assigned to the first task; and automatically assigning the first task to the second group, upon determining that the first faction is below a first predetermined value.

In accordance with yet another aspect of the present invention, there is provided a non-transitory tangible processor readable medium storing processor executable instructions that when loaded into a device with memory coupled a processor, adapt the processor to: define a legal service process, and a plurality of tasks associated with the process in response to user input, the tasks including a first task and a second task; define a process level service level agreement (PLSLA) for the process; define task level service level agreements including at least a first task level service level agreement (TLSLA) for the first task and a second TLSLA for the second task, the first TLSLA and the second TLSLA including a first deadline and a second deadline respectively; assign the first task to a first user belonging to a first group, the first group including legal professionals that are geographically located in a first location; assign the second task to a second user in a second group, the second group including legal professionals that are geographically located in a second location different from the first location; store data representative of the process, each of the tasks, the first TLSLA, the second TLSLA, the PLSLA, each user and each group and assignments, in the memory; send a first notification message upon a current time being within a first threshold relative to the first deadline; determine a first fraction of legal professionals other than the first user, within the first group, that are available to be assigned to the first task; and automatically assign the first task to the second group, upon determining that the first faction is below a first predetermined value.

### BRIEF DESCRIPTION OF THE DRAWINGS

Embodiments will now be described more fully with reference to the accompanying drawings in which:

FIG. 1 depicts a simplified block diagram of a software architecture for a workflow automation system, exemplary of an embodiment of the present invention;

FIG. 2 depicts a simplified block diagram of a networked computerized workflow automation system having the software architecture depicted in FIG. 1;

FIG. 3 is a flowchart that illustrates steps taken by a business process designer to define a business process using the workflow automation system of FIG. 2;

FIG. 4 is a flowchart of steps taken by a new user to take over a task assigned to another user, in order to complete the task;

FIG. 5 is flowchart that summarizes the steps taken by a new user that takes over a task, as depicted in FIG. 4 but assigns the task back to the originally assigned user;

FIG. 6 is a flowchart diagram of an exemplary sequence of steps taken by a user having the appropriate administrative privileges to reassign tasks;

FIG. 7 is a flow diagram illustrating various tasks and their flow of execution which may be dynamically altered as needed;

FIG. 8 is a simplified schematic diagram of a law firm having the workflow system of FIG. 2 deployed across two branches in two different geographic locations, each branch location having its own unique set of users; and

FIG. 9 is flowchart of an exemplary sequence of tasks executed by the workflow automation system depicted in FIG. 8.

### DETAILED DESCRIPTION

The present invention is directed to workflow automation systems that are adaptable and flexible enough to accommodate modifications easily and inexpensively. Embodiments of the present invention describe rule-based, dynamic workflow automation systems that are especially suited for use in professional service firms such as law firms to facilitate timely and transparent service delivery to clients.

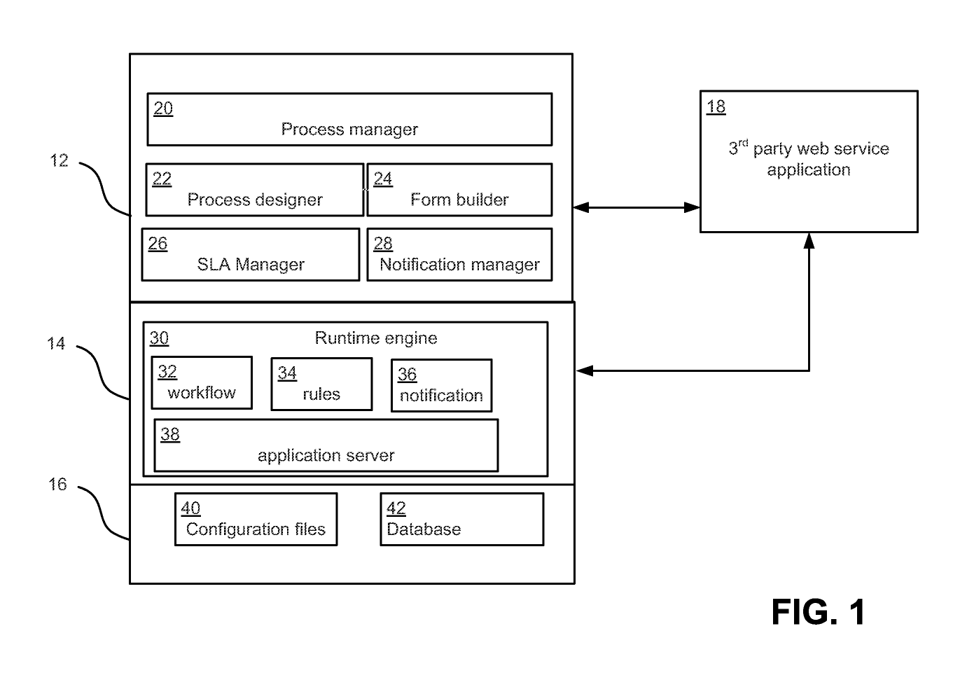

FIG. 1 depicts a simplified architectural block diagram of a workflow automation system exemplary of an embodiment of the present invention. As depicted, the architecture includes web application layer 12, a business services layer 14, and a persistence layer 16. Each of the layers also includes several modules used to accomplish the functions of the layer. Web application layer 12 includes a process manager 20, a process designer 22, form builder 24, a service level agreement (SLA) manager 26 and a notification manager 28.

The services layer 14 includes a runtime engine 30 which contains a workflow engine 32, a rules engine 34, a notification engine 36 and an application server 38.

The persistence layer 16 includes a database 42 and rules configuration files 40. The persistent layer 16 may also include additional configuration files, registry entries and the like, that may be used to store settings and other data in a persistent manner.

A third party web service or application 18 may be accessed by the web application layer 12 and/or the business services layer 14 over a data network. System 10 may be deployed in a computing device such as a laptop or desktop personal computer, a tablet computer, a slate computer, a smart-phone, a server computer, or any other suitable computing device. In addition, system 10 may be deployed in a networked environment, in which one or more of the layers execute in one or more distinct physical computing devices, interconnected by a local area network, a WiFi network, or the like.

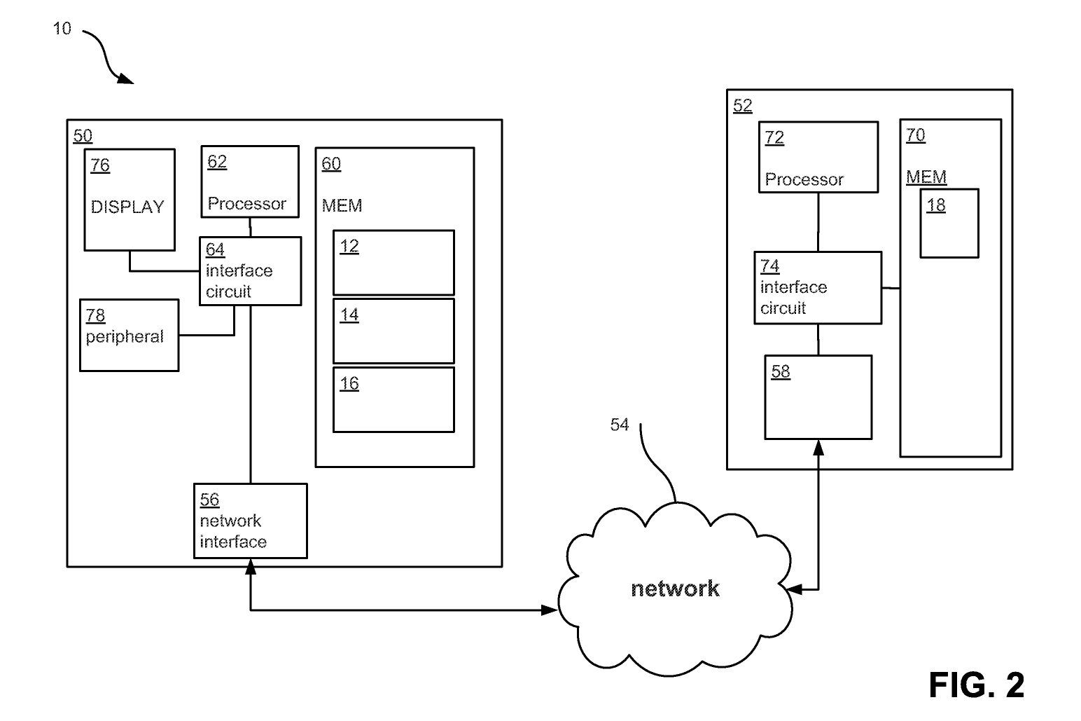

FIG. 2 depicts a simplified block diagram of a workflow automation system 10. Workflow automation system 10 includes a computing device 50 used to deploy software layers described in FIG. 1, and a computing device 52 executing application server 18. Computing device 52 executing application server 18 may be provided by a third-party. Each of the computing devices 50, 52 contain network interfaces 56, 58 respectively that allow the two computing devices to exchange data over a data network 54. Network 54 may be a local area network (LAN), a wide-area network (WAN), or the internet. Network 54 may be implemented as a wired, wireless or hybrid network.

As will be appreciated by those skilled in the art, each of the computing devices 50, 52 may be made up of one or more internetworked server computers. For example, the computing device 50 may include a presentation layer host in the form of a desktop computer, a business service layer server computer, and a database server computer that are internetworked on a local area network (LAN) in some embodiments. Moreover, data communication between computing device 50 and third-party server computing device 52 may take place using one or more proxy servers, firewalls, routers, modems and the like. Many hardware configurations are possible and will be known to persons of skill in the art.

The computing device 50 includes at least a processor 62, memory 60 and a network interface 56 interconnected by an interface circuit 64. The interface circuit 64 is also used for interconnection with input and output (I/O) components such as a display 76 which may be a touch screen, and optionally one or more peripherals 78 such as keyboards, electronic mice and the like.

The computing devices 52 includes a processor 72, memory 70 and a network interface 58 interconnected by an interface circuit 74. The interface circuit 74 is also used for interconnection with input and output components such as a display which may be a touch screen, and optionally one or more peripherals such as keyboards, electronic mice and the like (not shown).

The processor 62, memory 60 and network interface 56 are in electrical communication with one another. The processor 72, memory 70 and network interface 58 are also in electrical communication with one another. Each memory 60, 70 may be in the form of volatile and/or non-volatile memory, including for example, a hard disk drive, random access memory (RAM), read-only memory (ROM), EEPROM, CD-ROM, DVD, flash memory, solid state memory and the like. Each interface circuit 64,74 may include system bus coupling the various computer components or peripherals such as display monitors, keyboards, touch panels, joysticks, mouse or other pointing devices, networking interfaces and the like to its respective processor. Many types of interface circuits are known including ISA (Industry Standard Architecture), MCA (Micro Channel Architecture), EISA (Extended Industry Standard Architecture), VLB (VESA Local Bus), PCI (Peripheral Component Interconnect), PCI-X (Peripheral Component Interconnect Extended), AGP (Accelerated Graphics Port), PCI Express (Peripheral Component Interconnect Express or PCI-e) and the like. Network interface 56, or network interface 58 may each be a wired or wireless network interface card that allows communication with other computers through a data network such as network 54.

In operation, system 10 may permit access to server 18 using one or more interfaces such as a set of predefined application programming interfaces (API), widgets and the like.

As noted above, many workflow management systems utilize standards such as the Business Process Modeling Notation (BPMN) specification which provides a graphical notation for expressing business processes in a Business Process Diagram (BPD), and the associated XML Process Definition Language (XPDL) specified by Workflow Management Coalition (WfMC) and other affiliated groups.

A concordance exits between the graphical notations of BPMN and the XML constructs of XPDL so that notations in BPMN are mapped to their equivalent notations in XPDL.

In one embodiment, workflow automation system 10 utilizes a rule based system that allows for alerts, escalations, and rerouting, and task creations that are based on service level agreements (SLA). SLA may be a process level service level agreement (PLSLA) or a task-level service level agreement (TLSLA).

Each task in a given process can be preconfigured with a particular task-level service level agreement using a rules language. When the TLSLA is in danger of being breached, for example is within a defined threshold relative to the deadline, signifying that the deadline for a task is about to become past due, the workflow system 10 invokes an appropriate remedial action. This remedial action may involve an alert notification sent in the form of email, text, visual indication, calendar entry etc.; automatic escalation or reassignment of the task; or creation of a new task to ensure that the associated PLSLA can be maintained. The newly created tasks may be created on an ad-hoc basis and assigned to different users or roles (groups).

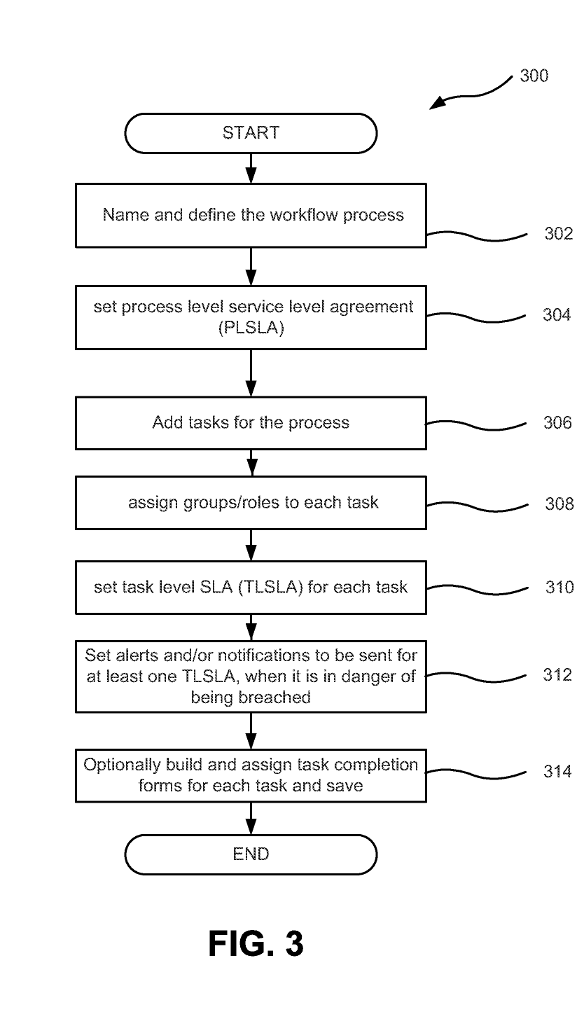

A flowchart 300 shown in FIG. 3, depicts an exemplary method of defining a legal service business process typically provided by a legal firm, using the workflow automation system 10. As depicted, a system user initially names and defines the workflow process (step 302) and sets or defines a process level service level agreement (PLSLA) for the defined process (step 304).

The system user then adds tasks (step 306) associated with the process defined in the previous step. The tasks may be added in a sequential flow. For example, in a process for which a first task and a second task are defined, the first task may be defined to end, before the second task begins so that the sequence is preserved. Of course, in other embodiments, tasks may be defined in parallel as well. The system user then assigns user groups/roles to the each task (step 308).

At the next step 310, the system user sets or assigns task level service level agreements (TLSLAs) to the newly added tasks. An example of a TLSLA may include a deadline by which a given task must be completed. The TLSLAs are designed with the parent process level service level agreement (PLSLA) in mind, so that if each of the child TLSLAs is met, then the associated parent PLSLA will also be met. For example, if the PLSLA calls for the process to be completed in a week, the individual child TLSLAs cannot collectively take up more than a week to be completed.

At step 312, the user sets alerts and notifications to assigned users or designated address. In one embodiment, the assigned users would be able to receive notifications in case of TLSLAs that are in danger of being violated. The notification message may also be sent to a predefined recipient address that need not necessarily be directly associated with the task's assigned users or groups or roles. For example, if the current time is within a threshold of the deadline of a particular task, then the system 10 may trigger or send the notification defined in step 312, to alert the impending deadline to a recipient. The notification message may be an email, a tweet, an alarm, a visual indication, a blog entry or a message on a predefined webpage, entry into a file or database, or the like.

At step 314, the system user optionally builds and assigns task completion forms for each of the tasks added and save data representative of the tasks, process, TLSLAs, PLSLA, users, user groups and the like in memory. The system then continues to carry out the tasks depicted in the flowchart of FIG. 3 as will detailed later. The user saves the process definition resulting from all previous steps and deploy the defied process into the target hardware environment forming part of the automation system 10. The method of flowchart 300 then terminates.

One particular embodiment of the workflow system 10 implemented by the applicants of the present invention is known as the Lex-Flow™. A simple rules language, which uses expressions that are close to natural language expressions, is used to define a business process such as the one depicted in flowchart 300. A workflow designer, forming part of the software for workflow system 10, is utilized by a user to define the workflow process. In one embodiment, each process has several tasks which will be defined for the process that should be executed in sequence in order to achieve the desired result of the process being defined.

After a task is created, it is assigned to either a user or a group of users or roles as depicted in step 306 of flowchart 300.

When a task is assigned to a group of users (e.g., legal professionals residing or working at a given physical location), any user that is a member of the group to which the task is assigned can accept the task and complete it. If a particular user has accepted the task, but did not complete it, other users in the group can take over the task and complete it, so that the workflow progresses as per the pre-configured TLSLA for the task. Alternately, a user may explicitly assign the tasks to a particular legal professional. In yet another alternative, the system may automatically assign the task to another group based on triggering mechanisms such as a notification message associated with the task indicating that the task in danger of failing to meet its associated TLSLA.

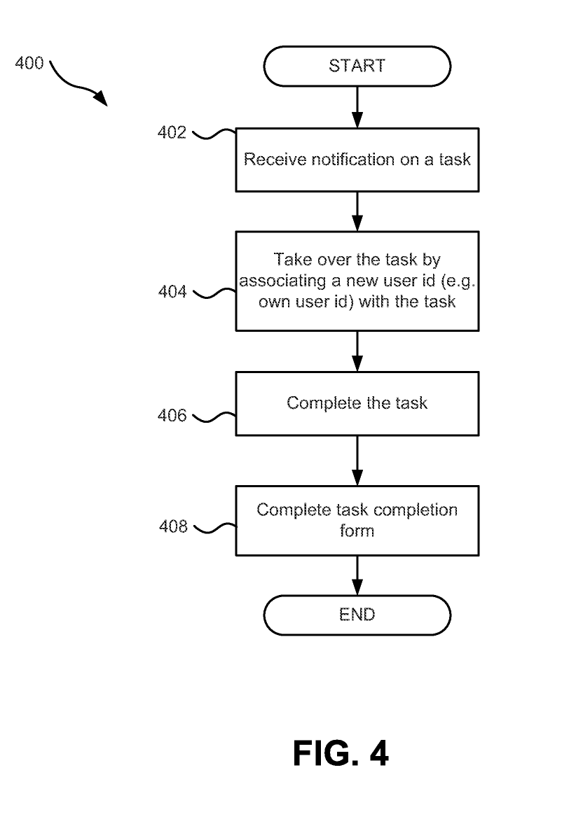

FIG. 4 depicts a flowchart 400 that summarizes the steps taken by a new user or legal professional that is a member of the same group or having the same role as the previous user that was originally assigned to the task, in order to take over the task. Initially, the new legal professional user receives notification on the task (step 402). In this embodiment, the notification may take the form of an email or a text message sent to the new user. In addition, other text bases messages such as blog entries, web posts, tweets to selected tweeter accounts and the like may be used. Further electronic calendar entries, or other visual or audio alarms may be used. The notification signifies that the task has yet not been completed and may be close to or past its deadline. If the current time is within a threshold duration defined relative to the deadline, the notification is be triggered. For example, the threshold duration may be one day, so the notification message will be sent upon the current time being within one day (i.e., one day or less) to the deadline associated with the task during the definition of the TLSLA as shown in FIG. 3. The new legal professional or user then takes over the task (step 404). The workflow automation system 10 accomplishes this by associating the new user's user identifier with the task identifier in a database or volatile or non-volatile memory or store forming part of system 10.

Afterwards, the new user completes the task (step 406). After the task is completed, the new user completes the task completion form (step 408) and the method terminates. At the end of the method summarized in flowchart 400, the task is marked as completed in workflow automation system 10 and the subsequent task in the defined process may be initiated.

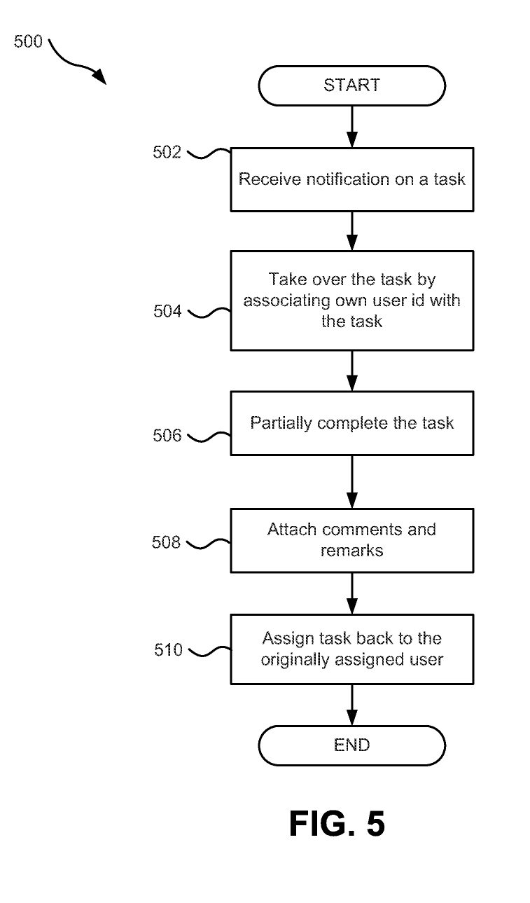

FIG. 5 depicts a flowchart 500 that summarizes the steps taken by a new user that takes over a task, as depicted in flowchart 400, but assigns the task back to the originally assigned user. Initially, the new user optionally receives notification on a task (step 502) indicating that task has not been completed. The new user then takes over the task (step 504), by associating his or her own user identifier with the task identifier using the workflow automation system 10. The new user may then partially complete the task (step 506). After the task is partially completed, the new user optionally includes comments to the task (step 508) and then reassigns the task back to the originally assigned user (step 510). The method then terminates. At the end of the method summarized in flowchart 500, the task is associated with the same original user that was assigned to the task, at the beginning of the flowchart 500 with comments and other additional remarks added by the new user.

Alternately, the task can be forwarded to another user who is not in the pre-configured list of users, groups or roles to which the task was originally assigned. This feature permits flexibility to deal with unforeseen circumstances such as unavailability of the originally assigned user, or inappropriate assignment of tasks to users that are not equipped to handle the task and the like.

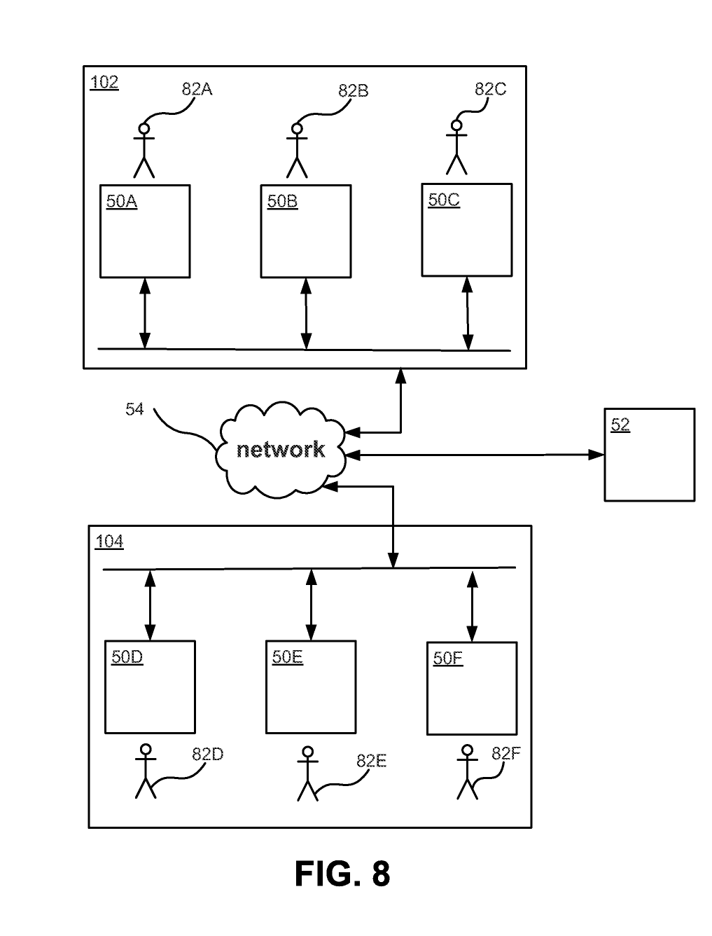

For example, a law firm having workflow system 10 deployed across the firm, may have one office in one geographic location (e.g., Chicago) and another one in another geographic location different from the first location (e.g., New York). A simplified schematic diagram depicted in FIG. 8 illustrates the scenario. In this exemplary embodiment, a first location 102 represents the Chicago office which has a first user 82A, a second user 82B, and a third user 82C each of which belong to a first role or group. A second location 104 represents the New York office. Users 82D, 82E, 82F each belong to a second group or role associated with the second New York location 104. Computing devices 50A, 50B, 50C, 50D, 50E, 50F forming part of the system 10 may each be substantially similar to the computing device 50, while computing device 52A is substantially similar to the computing device 52 described earlier with reference to FIG. 2.

In one embodiment, a given task is assigned to the first user 82A who works in the Chicago office location 102. As a result of an unforeseen event such as severe weather or a strike, all of the users 82A, 82B and 82C in the first group associated with location 102 may be unavailable or unable to work on the assigned task. The unavailability of the users 82A, 82B and 82C of the first group may be determined by their last login time in system 10, or by an explicit message from the users to a predetermined email address or telephone number, or by any authorized user who may mark each account associated with user 82A, 82B, 82C in system 10 as being unavailable to be assigned the given task specifically or any task in general. Many other options of indicating the unavailability of users, such as suspending user accounts, maintaining a list, time outs based on polling, and the like are possible and will be readily understood by persons of skill in the art.

In this case, user 82D in the New York office may take over the task assigned the first user 82A in the Chicago office, and complete it. Although the fourth user 82D is not the same group as the first user 82A, the flexibility of system 10 allows user 82D to fake over the task assigned to user 82A. As a result, the task can still be completed and the associated task level service lever agreement fulfilled, even though the roles originally assigned to the task are unavailable to work on the task.

In some embodiments, system 10 may automatically assign the task to the second group in New York upon determining that the TLSLA for the task is in danger of being violated, instead of waiting for input from a new user 82D in the New York office to voluntarily take over the task assigned the first user 82A. For example upon receiving an indication of a notification associated with the task, and after determining that none of the other users in the first group (i.e., users 82B and 82C in location 102) are available, the system 10 will automatically assign the task to the second group in location 104 (i.e., New York).

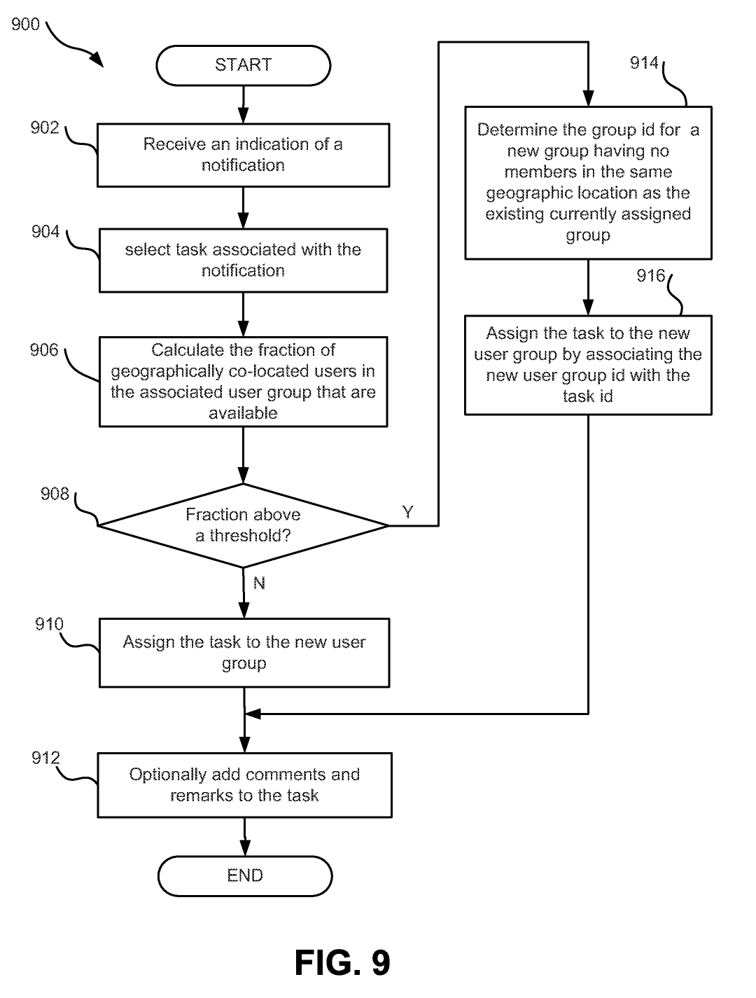

An exemplary sequence of tasks executed by system 10 in such a scenario is depicted in flowchart 900 of FIG. 9. Initially the system receives an indication of a notification (step 902). This indication or notification is the result of the TLSLA (which includes a deadline) being in danger of violation due to the inability of the assigned user 82A to complete the task before a defined threshold relative to the deadline for the task (e.g. 24 hours or two days or 5 hours, etc.). If the current time is within this threshold from the deadline, then the notification will be sent and the system 10 determines that the task should be reassigned. The system may optionally wait for some time for the task to be taken over by a user. The system 10 selects the associated task (step 904) and then calculates the number or fraction of users in the first geographic location (i.e., Chicago) that are available to take over the task (step 906). This fraction will give an indication of the probability of an event which may be unforeseen as severe weather, a strike, an evacuation, power outage, or the like at the first location 102. If the fraction is at or below a threshold (step 906), then the first group is considered unavailable. If, for example, the computed fraction is 0, then none of the users 82A, 82B, 82C at the first location are deemed available to take over the task. The system 10 automatically determines a different group—e.g. the second group in location 104 (step 914) and then assigns the task to this new second group (step 916). That is, the task is assigned to at least one of the users 82D, 82E, 82F. The first and second groups have no common member that are in the same location or co-located.

If the fraction is above a threshold in step 906 then this indicates that another user within the first group (e.g., user 82B or user 82C in location 102 or in the Chicago office) is available to take over the task and the system 10 may assign the task to another user (i.e., user 82B or user 82C) in the same first group (step 910).

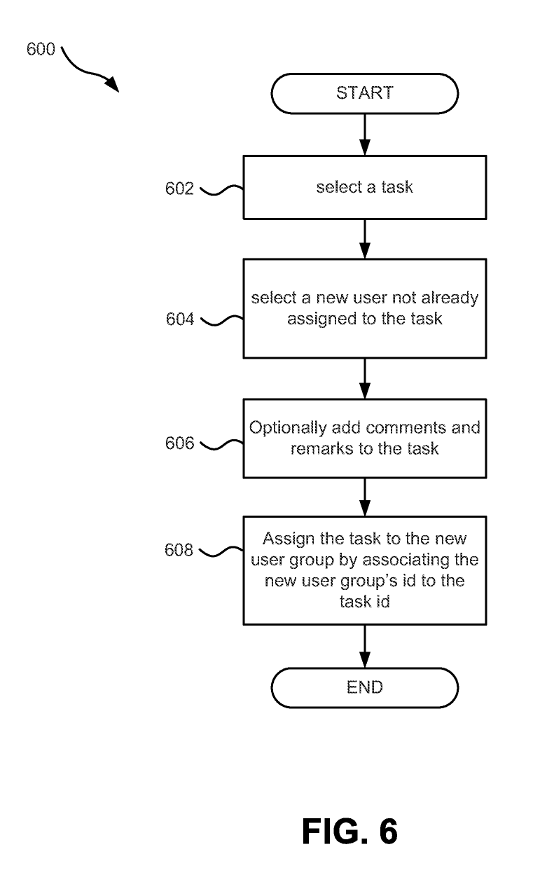

An exemplary sequence of steps taken by a user having the appropriate administrative privilege to reassign tasks is depicted in flowchart 600 of FIG. 6. Initially in step 602, the administrative user selects a task. The administrative user then selects a new user (step 604) that is not already associated with the task. That is, the new user is not a member of a group or role initially assigned to the task. At step 606, the administrative user optionally adds comments and remarks to the task that may be useful to the newly assigned user or other users examining the tasks. It may for example explain why the new user was assigned. Finally, the administrative user assigns the new user selected at step 604 to the task by associating the new user's identifier and the task identifier using the workflow automation system 10.

As may be appreciated, various similar, dynamic assignments, and reassignments of tasks among users are possible. These arrangements may be initiated by users with administrative privileges in some cases, or the assigned users themselves in others, or previously unassigned users in yet other cases. The illustrated flowcharts in FIGS. 4 to 6 are thus only exemplary.

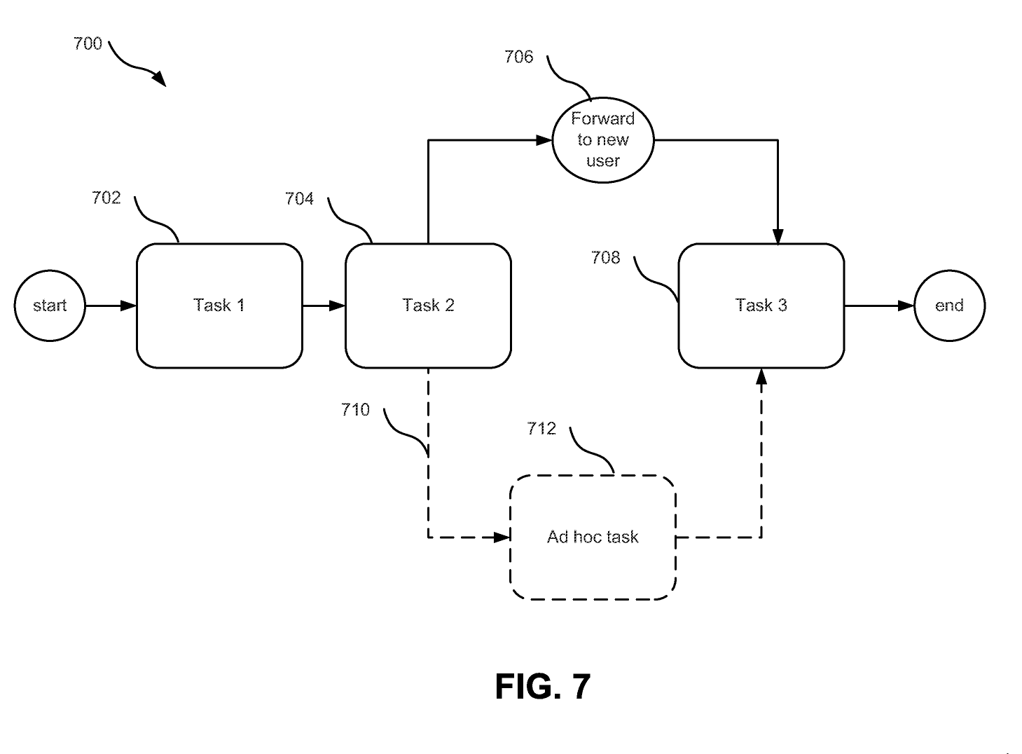

FIG. 7 depicts a flexible process execution flow diagram exemplary of an embodiment of the present invention. As depicted, a series of tasks 702, 704, 708 are created for sequential execution during a process definition. As noted above, a task may be forwarded to another new user as shown by activity 510. After the new user completes the task 704 the next task 708 is initiated.

As depicted, after the second task 704 is completed, a new ad hock task 712 may be optionally created. The new ad hoc task 712, if created, must be completed before the subsequent task 708 is initiated. The creation of the new task 712 is dynamic as depicted by the dashed transition arrow 710, and need not be part of the original process definition.

Further, while a user is working on a currently assigned task, he can create a new associated task and assign the new associated task to another user and wait until the new associated task is completed, before he completes the current task assigned to him. This kind of functionality is required in professional services firms when the user requires additional inputs to complete his task. For example, at a law firm, a first attorney may be working on a task to prepare an immigration petition for an H1B visa on behalf of a client, followed by a task to file the petition. The attorney identifies that a foreign education credentials evaluation is needed for the client to file the petition. The attorney then creates a new task to obtain the foreign education credentials evaluation documentation. The new task may be expected to take two days. The attorney may thus optionally delays the completion time (or other TLSLA parameter) for the initial task by the amount introduced by the new task. After the new ad hoc task competes, the task of filing the petition may then be completed. In this embodiment, after receiving the foreign education credentials evaluation documentation, the attorney files the petition.

Similarly, while configuring a workflow using exemplary embodiments of the workflow automation system 10, it is possible to induce a delay after completing one task and before starting the next task. This would be useful when it is known that the next task can actually be taken up only after a certain number of hours or days. This can be accomplished by creating a phantom task or empty task that merely induces a delay and thus prevents unnecessary piling up of pending tasks, when it is known that there is nothing that can be done until a certain day or hour.

Multiple branching is made possible in alternate embodiments of system 10 to accommodate scenarios where parallel task execution is required. Both inclusive and exclusive joins may be supported whenever such branching takes place. A workflow can be configured to wait until all branched parallel tasks are completed or it can be allowed to move further without waiting for completion of the branched parallel tasks.

Flexible workflow process handling as narrated in the above features is very useful in today's highly dynamic professional service environments that adhere to stringent SLAs and work with customers who are pressed for time, and expect expedited service delivery without compromising on process and transparency.

Each task in the workflow can be associated to a task form designed using the form builder 24 (FIG. 1), which includes a drag and drop interface. These web forms are compatible across all devices making it easier to complete the workflow tasks even from connected mobile devices like smart phones and tablets equipped with installed browsers and wireless data connectivity.

Alerts and notifications in system 10 may be subscription based. A user can thus opt to receive each type of notification defined for an assigned task, through any one of the available channels like email, text messaging, Facebook™, Twitter™, iOS™ notifications, Android™ notifications, etc. A user can set repeating reminders for a set of alerts/notifications, just so that he or she will not miss important events, using the notification manager 28 depicted in FIG. 1.

Moreover, notifications from the workflow automation system 10 may be integrated into an electronic calendar of a user for seamless reminder setup just like any other electronic calendar event.

Process manager 28 of FIG. 1 may include an associated dashboard that provides a bird's eye view of all the workflow users, processes, tasks, and their SLA status at a glance to a user with the appropriate administrative or other permission or access level. The dashboard may include a drill-down capability which allows the administrator to view the details of a particular selected task and to perform various actions such as aborting or completing a workflow or a task; reassign one or more tasks; re-evaluating assignments and SLAs based on modified process configurations; moving currently running processes to new versions of the process and so on.

In some embodiments, all the workflow user interfaces are available in the form of access controlled and widget interfaces or portlets that can be easily embedded into third party applications, without requiring additional programming. Business services layer 14 may be exposed as secure web service for integration into third party applications.

In yet other alternate embodiments, workflow automation system 10 may be provided either entirely, or in part, as a multi-tenant cloud-hosted service to professional services firms or any other third-party application vendors or service providers using a software-as-a-service (SaaS) model. Clients would subscribe to the software service which is delivered over the internet using a web-browser with little need for new hardware infrastructure and no need local maintenance as the entire application is hosted, updated and maintained in the cloud.

In yet another embodiment, workflow automation system 10 may be provided as a non-transitory tangible processor readable medium such as a CD, DVD or memory stick storing processor executable instructions. When loaded into a computing device with memory coupled a processor, the instructions adapt the processor to: define a legal service process, and a plurality of tasks associated with the process in response to received user input, the tasks including a first task and a second task; define a process level service level agreement (PLSLA) for the process; define task level service level agreements including at least a first task level service level agreement (TLSLA) for the first task and a second TLSLA for the second task, the first TLSLA and the second TLSLA including a first deadline and a second deadline respectively; assign the first task to a first user belonging to a first group, the first group including legal professionals that are geographically located in a first location; assign the second task to a second user in a second group, the second group including legal professionals that are geographically located in a second location different from the first location; store data representative of the process, each of the tasks, the first TLSLA, the second TLSLA, the PLSLA, each user and each group and assignments, in the memory; send a first notification message upon a current time being within a first threshold relative to the first deadline; determine a first fraction of legal professionals within the first group that are available to be assigned to the first task; and automatically assign the first task to the second group, upon determining that the first faction is below a first predetermined value.

Although embodiments have been described above with reference to the accompanying drawings, those of skill in the art will appreciate that variations and modifications may be made without departing from the spirit and scope thereof as defined by the appended claims.

What is claimed is:

1. A computerized method of workflow automation for use in a law firm, implemented by executing processor executable instructions stored in memory on a processor coupled to said memory, the method comprising:
a) defining a process and a plurality of tasks associated with the process, the tasks comprising a first task and a second task;
b) defining a process level service level agreement (PLSLA) for the process;
c) defining task level service level agreements comprising at least a first task level service level agreement (TLSLA) for the first task and a second TLSLA for the second task, the first TLSLA and the second TLSLA comprising a first deadline and a second deadline respectively;
d) assigning the first task to a first user belonging to a first group of legal professionals that are geographically located in a first location, and assigning the second task to a second user in a second group of legal professionals that are geographically located in a second location different from the first location;
e) storing data representative of the process, each of the tasks, the first TLSLA, the second TLSLA, the PLSLA, and assignments in the memory;
f) upon the current time being within a first threshold duration relative to the first deadline;
i) sending a first notification message;
ii) determining a first fraction of the legal professionals other than the first user within the first group that are available to be assigned to the first task; and
iii) automatically assigning the first task to another group having no common members with the first group, upon the first faction being less than a first predetermined value.

2. The method of claim 1, wherein the first group consists of said legal professionals that are geographically located in the first location and the second group consists of said legal professionals that are geographically located in the second location, and said another group is the second group.

3. The method claim 2, wherein the notification message comprises one of: email, text message, tweet, web entry, blog entry, a visual message and an audio message.

4. The method claim 3, wherein the first fraction is zero so that none of the legal professionals other than the first user within the first group are available to be assigned to the first task.

5. The method claim 1, wherein said another group is different from the second group, the method further comprising:
upon said current time being within a second threshold relative to the second deadline;
sending a second notification message;
determining a second fraction of the legal professionals within the second group other than the second user that are available to be assigned to the second task; and
upon the second faction being below a second predetermined value, automatically assigning the second task to said another group, said another group having no common members with the second group.

6. The method of claim 5, wherein said another group is different form both of the first group and second group.

7. The method of claim 4, further comprising assigning the first task back to the first group from said another group.

8. The method of claim 7, further comprising adding notes to the first task by said another group prior to said assigning the first task back the first group.

9. The method of claim 5, wherein the first task ends before the second task begins, the method further comprising:
a) inserting a third task in the process that ends before the beginning of the second task; and
b) assigning the third task to a third group having no members in common with either of the first and second groups.

10. The method of claim 9, wherein the third task introduces a delay in starting the second task, and wherein all members of the first group and the second group belong to the law firm, and said third group represents a third party service provide external to the law firm having no members belonging to the law firm.

11. The method of claim 10, wherein the first task comprises filing an immigration petition for an H1B visa on behalf of a client; the second task comprises filing the petition; and the third task comprises obtaining a foreign education credentials evaluation document for the client.

12. A system for workflow automation in a law firm comprising: a processor; and memory coupled to the processor, the memory storing processor executable instructions comprising:
a) instructions for defining a legal service process, and a plurality of tasks associated with the process in response to user input, the tasks comprising a first task and a second task;
b) instructions for defining a process level service level agreement (PLSLA) for the process;
c) instructions for defining task level service level agreements comprising at least a first task level service level agreement (TLSLA) for the first task and a second TLSLA for the second task, the first TLSLA and the second TLSLA comprising a first deadline and a second deadline respectively;
d) instructions for assigning the first task to a first user belonging to a first group comprising legal professionals that are geographically located in a first location;
e) instructions for assigning the second task to a second user in a second group comprising legal professionals that are geographically located in a second location different from the first location;
f) instructions for storing data representative of the process, each of the tasks, the first TLSLA, the second TLSLA, the PLSLA, each user, each group and assignments, in the memory;
g) instructions for, upon the current time being within a first threshold duration relative to the first deadline:
i) sending a first notification message;
ii) determining a first fraction of said legal professionals other than the first user within the first group that are available to be assigned to the first task; and
iii) automatically assigning the first task to the second group, upon determining that the first faction is below a first predetermined value.

13. The system of claim 12, wherein said processor and memory comprise a plurality of computing devices internetworked by a data network.

14. The system of claim 12, wherein the first group consists of said legal professionals that are geographically located in the first location; and the second group consists of said legal professionals that are geographically located in the second location.

15. The system of claim 14, wherein the first fraction is zero so that none of the legal professionals other than the first user within the first group are available to be assigned to the first task.

16. The system of claim 15, the processor executable instructions further comprising:
a) instructions for sending a second notification message upon the current time being within a second threshold relative to the second deadline;
b) instructions for determining a second fraction of the legal professionals within the second group other than the second user that are available to be assigned to the second task;
c) upon the faction being below a second predetermined value, automatically assigning the second task to the first group.

17. The system of claim 16, wherein the notification message comprises one of: email, text message, tweet, web entry, blog entry, a visual message and an audio message alerting the respective group that the criteria has been met.

18. The system of claim 17, wherein the first task ends before the second task begins, the processor executable instructions further comprising:
a) instructions for inserting a third task in the process that ends before the beginning of the second task; and
b) instructions for assigning the third task to a third group having no members in common with either of the first and second groups.

19. A non-transitory tangible processor readable medium storing processor executable instructions that when loaded into a device with memory coupled a processor, adapting the processor to:
a) define a legal service process, and a plurality of tasks associated with the process in response to user input, the tasks comprising a first task and a second task;
b) define a process level service level agreement (PLSLA) for the process;
c) define task level service level agreements comprising at least a first task level service level agreement (TLSLA) for the first task and a second TLSLA for the second task, the first TLSLA and the second TLSLA comprising a first deadline and a second deadline respectively;
d) assign the first task to a first user belonging to a first group, the first group comprising legal professionals that are geographically located in a first location;
e) assign the second task to a second user in a second group, the second group comprising legal professionals that are geographically located in a second location different from the first location;
f) store data representative of the process, each of the tasks, the first TLSLA, the second TLSLA, the PLSLA, each user and each group and assignments, in the memory;
g) send a first notification message upon a current time being within a first threshold relative to the first deadline;
h) determine a first fraction of legal professionals other than the first user, within the first group, that are available to be assigned to the first task; and
i) automatically assign the first task to the second group, upon determining that the first faction is below a first predetermined value.

20. A non-transitory tangible processor readable medium of claim 19, the processor executable instructions further adapting the processor to:
a) send a second notification message upon the current time being within a second threshold relative to the second deadline;
b) determine a second fraction of legal professionals within the second group that are available to be assigned to the second task; and
c) upon the second faction being below a second predetermined value, automatically assign the second task to the first group upon said current time being within a second threshold relative to the second deadline.
